(19) United States
(12) Patent Application Publication
(10) Pub. No.: US 2010/0205213 A1
(43) Pub. Date: Aug. 12, 2010

(54) NON-EXACT CACHE MATCHING

(75) Inventors: Andrei Broder, Menlo Park, CA (US); Vanja Josifovski, Los Gatos, CA (US); Shanmugasundaram Ravikumar, Santa Clara, CA (US); Sandeep Pandey, Santa Clara, CA (US); Serguei Vassilvitskii, New York, NY (US); Flavio Chierichetti, Rome (IT)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/370,306

(22) Filed: Feb. 12, 2009

(51) Int. Cl. G06F 17/30; G06F 12/08

(52) U.S. Cl. 707/780; 711/118; 711/E12.017

(57) ABSTRACT

The subject matter disclosed herein relates to returning cached object results based at least in part on a non-exact comparison with a query key.

### BACKGROUND

1. Field

The subject matter disclosed herein relates to data processing, and more particularly to methods and apparatuses that may be implemented to selectively return cached object results.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. With so much information being available, advertising on the Internet often allows advertisers to target audiences viewing their advertisements. Use of the Internet for online advertising facilitates a two-way flow of information between end users and advertisers. For example, an end user may request an advertisement and in doing so may provide information in the form of data that describes the end user in some manner. Conversely, traditional print and “hard copy” advertising may constitute a one-way flow of information from advertisers to end users.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a diagram illustrating a procedure for publishing of online advertising in accordance with one or more exemplary embodiments.

FIG. 2 is a diagram illustrating a procedure for operating an object cache in accordance with one or more exemplary embodiments.

FIG. 3 is a diagram illustrating a procedure for operating an object cache in accordance with one or more exemplary embodiments.

FIG. 4 is an illustration of a ball-like operative organization that may be associated with an object cache in accordance with one or more exemplary embodiments.

FIG. 5 is a schematic block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

The World Wide Web includes vast amounts of information or content that may be displayed to an end user. For example, an end user may utilize an application program, such as a web browser, to display one or more electronic documents (such as web pages) provided by one or more content providers or web site operators. Under some circumstances, a web site operator or content provider may desire to display one or more online objects along with content requested by an end user. By way of example but not limitation, an object may include an advertisement and/or other like content.

As used herein, for example, the phrase “online advertisement,” “advertising,” and/or the like may include online pop-up ads, banner ads, and/or the like content associated with an object. Under some circumstances, it may be desirable to determine which online advertisement to display with a particular electronic document based at least in part on user centric information and/or electronic document centric information. For example, an advertisement for an auto dealership may, under some circumstances, be more effective if displayed along with an article relating to an auto show rather than with an article relating to a movie review.

As used herein, the term “electronic document” may include any information in a digital format, of which at least a portion may be perceived in some manner (e.g., visually, audibly) by a user if reproduced by a digital device such as, for example, a computing platform. For one or more embodiments, an electronic document may comprise a web page coded in a markup language, such as, for example, HTML (hypertext markup language), and/or the like. However, the scope of claimed subject matter is not limited in this respect. Also, for one or more embodiments, such electronic documents may comprise one or more elements. Such elements in one or more embodiments may comprise text, for example, as may be displayed as part of a web page presentation. Also, for one or more embodiments, the elements may comprise a graphical object, such as, for example, a digital image. In a particular implementation, a web page may contain embedded references to images, audio, video, other web documents, etc. One common type of reference used to identify and locate resources on the web is a Uniform Resource Locator (URL).

Some exemplary methods and systems are described herein that may be used to return cached object results based at least in part on a non-exact key based comparison. In some portions of the description below, a key and object result pair for a request item p may be referred to as a key-value pair <key(p), val(p)>. In such a case a requested item may be specified by key(p), and val(p) may be returned as the object result.

An object cache may be utilized as a part of an object search engine. An object search engine may maintain an object cache as a memory component of the object search engine. An object cache may be utilized for returning one or more cached object results as an object result in response to an object query. Such an object result may, for example, include one or more online advertisements, which may be described below as an object unit. Such an object result may include a creative component. For example, such an object result may include text, graphic or video data (herein referred to as “creative component”). Additionally, metadata associated with such creative components may include one or more keyword terms associated with the object result. An object result, such as, for example, relating to advertisements, may be delivered to an end user device based at least in part on one or more forms of online marketing processes, such as on contextual advertising, search advertising, search engine marketing, sponsored listings, and/or the like, and/or combinations thereof, for example.

In the example implementations that follow an object cache, an object search engine may be associated with one or more cached advertisements. It should be understood, however, that advertisements represent only one example of a type of object and/or collection of objects to which the techniques provided herein may be applied. Thus, claimed subject matter is not necessarily intended to be limited in this manner.

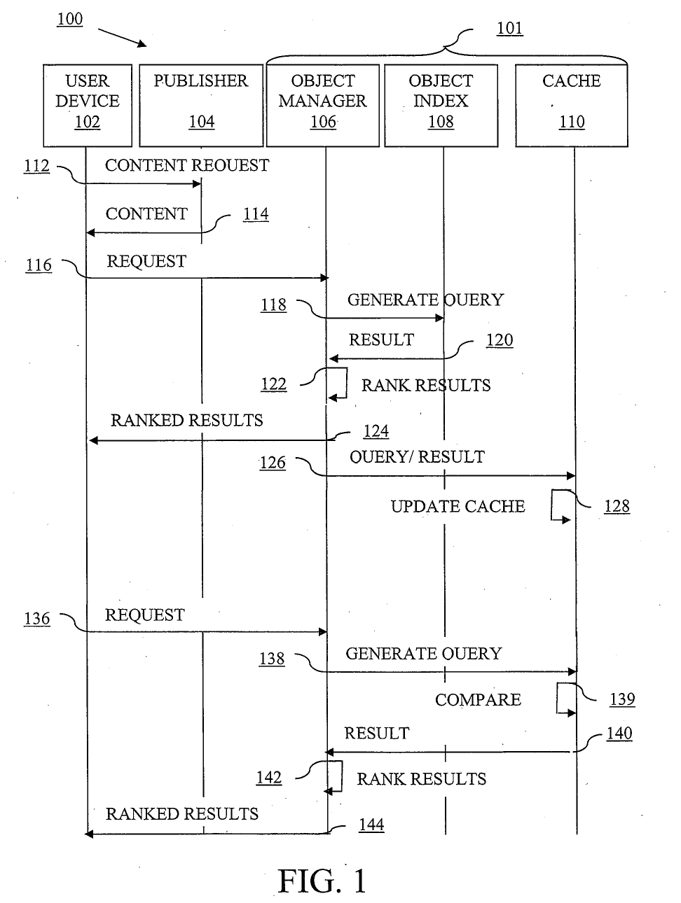

Referring to FIG. 1, a flow diagram illustrates a process for publishing of online advertising in accordance with one or more embodiments. Although process 100, as shown in FIG. 1, comprises one particular order of blocks, the order in which the blocks are presented does not necessarily limit claimed subject matter to any particular order. Likewise, intervening blocks not shown in FIG. 1 and/or additional blocks not shown in FIG. 1 may be employed and/or blocks shown in FIG. 1 may be eliminated, without departing from the scope of claimed subject matter.

Process 100 depicted in FIG. 1 may in certain embodiments be implemented in software, hardware, and/or firmware, and may comprise discrete operations. As illustrated, an object search engine 101 may include an object manager 106, an object index 108, and/or an object cache 110. Additionally or alternatively, object search engine 101 may include additional components not illustrated here. Object manager 106 may be coupled in communication with one or more publisher devices 104 associated with one or more publishers. Object manager 106 may include an object server operative to handle requests from publisher devices 104 and transmit data to publisher devices 104.

During typical online activity, a user device 102 may request a page and/or other like data file(s) of content from publisher device 104, as illustrated at block 112. Publisher device 104 may, in turn, return a content page to the user device, where the content page may contain a link and/or the like to a request for an object result from object manager 106, as illustrated at block 114. In the illustrated embodiment, object manager 106 may handle object requests for object results from user devices 102, as illustrated at block 116. Such an object request for object results may include an HTTP request for object results initiated by a content page provided by publisher devices 104 to user devices 102. For example, a request for object results may contain one or more current contextual features associated with a given end user including user centric data and/or publisher centric data. Such user centric data may include or otherwise be associated with an end user demographic (e.g. age, gender, income, and/or the like), end user location (e.g. continent, country, state/providence, city, zip, and/or the like), time (e.g. end user time, advertiser time, coordinated universal time (UTC), and/or the like), end user interests (e.g. sports, politics, and/or the like), and/or the like, and/or combinations thereof. Such publisher centric data may include or otherwise be associated with publication content (e.g. shopping, search, and/or the like), publication Uniform Resource Locator (URL), publication domain, publication site, and/or the like, and/or combinations thereof. For example, an object request may specify features such as user centric data including end user gender, such as male or female, and/or the like. Similarly, an object request may specify features such as user centric data including end user age, such as age in years, by birthday, and/or the like, for example. Likewise, an object request may specify features such as user centric data including end user location, such as a geographic location, address, latitude and longitude, Global Positioning System location, and/or the like, for example. Further, an object request may specify features such as user centric data including end user time, such as a time of day, time zone, and/or the like, for example. Likewise, an object request may specify features such as publisher centric data including publication content, such as topic areas associated with such content, key words associated with such content and/or the like, for example. Further, an object request may specify features such as publisher centric data including publication URL, publication domain, and/or publication site that may refer to all or a portion of a string of characters used to represent a resource available on the Internet, for example. For example, an object request may specify that the requesting content page is directed towards “sports”, located on the domain “example.com”, that the end user is a male between the ages 18 and 25, and that the end user is located in California.

In the illustrated embodiment, object manager 106 may be operative to generate an object query based at least in part on such an object request, as illustrated at block 118. Such an object query may be sent to object index 108. Object index 108 may provide an index of object units. For example, index 108 may parse a given object into indexable terms, such as keyword terms that may be associated with concepts and/or entities. Such concepts and/or entities may include, but are not limited to, words, phrases, categories, topics, geographical information, and/or the like. Index 108 may index such terms and may store information regarding which object units contain a given concept and/or entity based at least in part on such indexed terms.

Object manager 106 may receive an object result set from index 108 based at least in part on object query 118, as illustrated at block 120. Object manager 106 may be capable of ranking such an object result set such that the most relevant ads in the object result set are presented to a user, according to descending relevance, as illustrated at block 122. For example, a first object in such a ranked object result set may be the most relevant in response to an object query. Likewise, a last object in such a ranked object result set may be the least relevant while still falling within the scope of the object query. Such a ranked object result set may comprise an object result that is transmitted to user device 102, as illustrated at block 124. In one embodiment, such ranking may consider user centric data and/or publisher centric data.

In some situations, it may be cost effective to use prior object query/object result searches in processing a subsequent object request. In order to facilitate such use of prior object query/object result searches, a cache 110 may be utilized. In one example, object search engine 101 may maintain object cache 110 as a memory component of object search engine 101, although the scope of claimed subject matter is not limited in this respect. For example, cache 110 may receive prior object queries and/or object results at block 126. Upon receiving such object queries and/or object results, cache 110 may be updated to incorporate additional object query/object result searches, as illustrated at block 128.

As illustrated at block 136, a subsequent object request may be received at object manager 106. Object manager 106 may in turn send a subsequent object query to cache 110, as illustrated at block 138. As illustrated at block 139, such a subsequent object query may be compared in some manner with one or more prior object queries stored in cache 110. Prior object results associated with such prior object queries may be identified based at least in part on such a comparison. Such identified prior object results may be returned to object manager 106, as illustrated at block 140. Such prior object results may be ranked by object manager 106, as illustrated at block 142, and returned to user device 102, as illustrated at block 144.

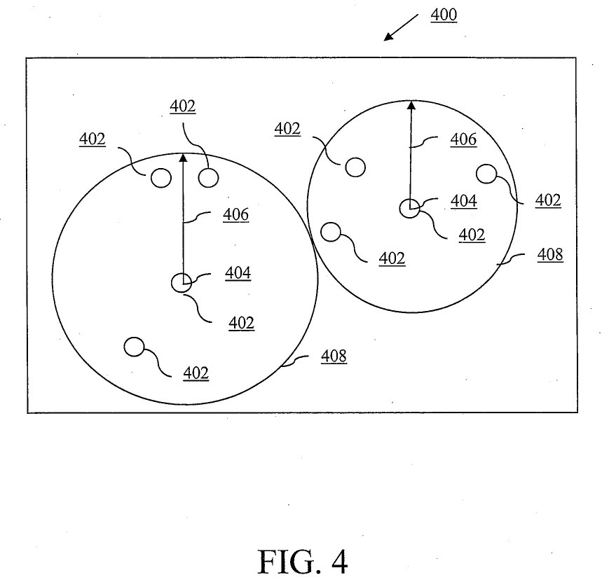

Referring to FIG. 4, a diagram illustrates a ball-like organization 400 for use with an object cache 110 (FIG. 1) in accordance with one or more exemplary embodiments. Ball-like organization 400 may be operatively represented in a metric space composed of a plurality of items. Such a metric space may be composed of a plurality of items 402. Such items 402 may represent previous object results and/or object queries that may be stored in cache 110 (FIG. 1). Such items 402 may be associated with a distance function defined among such items 402. Such a distance function may be utilized to determine the similarity between two given items 402. For example, such a distance function may be utilized to determine the similarity between a first object query and a second object query. In an object manager context, a search of a given set of items may be performed based on a given object query. In such a case, a cached object result may be identified based on a comparison of such a given object query with the given set of items within such a metric space. Additionally or alternatively, such a distance function may be based on object query feature similarity, or object result similarity, or both.

For example, such items 402 represented within metric space may be operatively associated with an individual ball center 404. In such a case, such items 402 may be represented based at least in part on a mapping of object query feature and/or object result features as vectors within metric space via such a distance function. For example, cache 110 (FIG. 1) may include a set of items 402 operatively distributed among a set of ball centers 404 with associated radius 406. In such a case such items 402 may be operatively associated with a given ball center 404 within the extension of a given ball 408 having a given radius 406 extending from such a ball center 404. Such a ball 408 may operatively include those items 402 that may be the closet items to a respective given ball center 404.

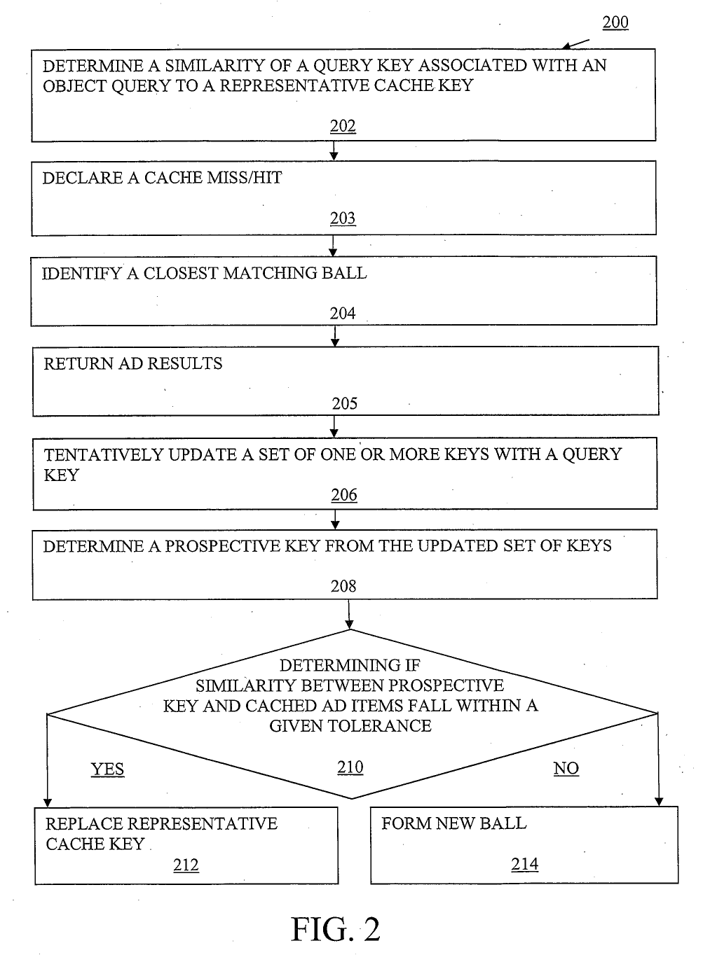

Referring to FIG. 2, a flow diagram illustrates a procedure 200 for operating an object cache in accordance with one or more exemplary embodiments. In operation, procedure 200 may be utilized to perform similarity caching in content-match systems, and/or the like. Procedure 200 may include a threshold objective that may dictate the efficiency-accuracy tradeoff during operation. Such a threshold objective may specify that a cache hit may be said to occur in cases where the similarity between keys associated with two items is more than a pre-specified threshold. As will be described below, procedure 200 may include a cache management policy that may operate in both least recently used (LRU) and/or least frequently used (LFU) based cache management policies.

As discussed above with regard to block 139, a subsequent object query may be compared with one or more prior object queries. More specifically, at block 202 a similarity between a query key associated with an object query and a representative cache key associated with one or more cached object results in an object cache may be determined. Such a determination of similarity may include a non-exact comparison. As used herein the term “non-exact comparison” includes key comparison procedures that may, but do not necessarily require, an exact match to declare a hit and/or miss to an object cache. For example, an exact match caching scheme may operate in the following way. On receiving a request for an item p specified by key(p), a cache is probed to check if it has p. If so, then this is called a hit and the cached item is used to serve the request. If p is not found in the cache, then this is called a miss and p is brought into the cache from a storage device. If the cache is full, then an existing cached item is evicted to make space for p. Conversely, there may be several applications where the concept of exact caching can be replaced with a non-exact type caching (also referred to herein as similarity caching). In such a case, non-exact type caching may serve query keys associated with an object query with cache keys that are “similar” enough to the query keys. In such a case, there may be a tradeoff between the similarity of offered items from the object cache to the requested items associated with an object query and an incurred disk access cost.

As used herein the term “key” includes some form of a condensed representation of a current or past object query that may, in some cases, be associated with a corresponding object result. In some portions of the description below, a query key and object result pair for a request item p may be referred to as a key-value pair <key(p), val(p)>. In such a case a requested item may be specified by key(p), and val(p) may be returned as the object result. Typically, the size of a key is insignificant compared to that of the value. One exemplary application, for instance, the size of a key may be roughly 1 KB while the size of a corresponding value can be 10 MB or more.

In one example, such a non-exact comparison may be based at least in part on determining if a similarity of a query key falls within a given tolerance as compared to a representative cache key. In one example, such a tolerance may be defined with respect to a utility function. Such a function util(•) may be utilized to control a tradeoff between a similarity of offered and requested items and input/output (IO) costs during cache maintenance. For instance, if util(s)=1 for s=1 and 0 otherwise, then such a formulation may be reduced to exact caching. In another example of such a utility function, which may be more relaxed than exact caching, util(s)=1 for s≧τ and 0 otherwise, where such a tolerance may be described as a threshold of τ≦1. A resulting objective may be utilized to manage an efficiency-accuracy tradeoff and may be referred to as a “threshold objective,” based at least in part on such a tolerance, as is discussed above with respect to FIG. 2.

More formally, in one example, a non-exact type caching (also referred to herein as similarity caching) procedure 200 may be described as follows: let b denote an average IO cost budget. In such a case, b may be defined as the fraction of cache misses, for example. Here, c(p) may denote the (cached) item offered by the caching policy for request p. Then for a given cache size, an IO budget B, and a list of requests (specified by query keys), say P, the goal of a caching policy may be to maximize the following formula:

$${\sum }_{p ∈ 𝒫} util ( sim ( c ( p ) , p ) ) , \qquad ( 1 )$$

subject to the IO cost being at most b. Here sim(p, q).[0, 1] may denote the similarity between keys of items p and q and util(s) may denote the utility of offering an item of similarity s to the requested item. Thus the objective may depend on the similarity function sim(•, •) and/or the utility function util(•).

In one example, at block 203, a cache miss or hit may be declared. For example, a cache miss or hit may be declared based at least in part on a comparison of a query key to representative cache keys at block 202. For example in cases where a threshold objective has a util(s)=1 for s≧τ and 0 otherwise, and where a given threshold/tolerance τ>0, a hit-or-miss determination may be made where a cache hit is said to happen if and only if there is a cached item with similarity of at least a given threshold/tolerance τ to a requested item. In such a case, a cache miss or hit may be declared based at least in part on a nearest-neighbor search within the cache.

More formally, in one example, a hit-or-miss determination in similarity caching may utilize a solution to a nearest-neighbor problem in high-dimensional space. In other words, given an item p, a cached item q may be obtained such that sim(p, q) may be maximized, where the similarity function may be defined on the space of the keys of the items. To do this efficiently, a locality sensitive hashing (LSH) may be utilized. In such a case, the keys of items may be hashed using an LSH function with the property that keys are hashed to the same value if and only if they are similar according to sim(•, •). For example, a weighted Jaccard measure may be utilized for the similarity between two vector-valued keys x=(x₁, . . . ) and y=(y₁, . . . ) with the following formula:

sim(x, y)= [symbol] min(xᵢ, yᵢ)/max(xᵢ, yᵢ). (2)

Additionally or alternatively, min-wise independent hash functions may be utilized in such a case.

At block 204, a closest matching ball from the ball-like organization of an object cache may be identified. As discussed above, an object cache may operatively comprise a ball-like organization comprising two or more balls 408 (FIG. 4). In such a case, a representative cache key may be operatively associated with a given ball center 404 (FIG. 4). Accordingly, individual balls 408 of an object cache may be operatively associated with respective representative cache keys. For example, a closest matching ball may be identified based at least in part on the comparison of a query key to representative cache keys at block 202. Note that more than one cached item can hit a requested item p; let Cτ(p) denote the set of such items. Thus, a cache hit may happens in cases where C_{τ}(p)≠Ø. Of the items in C_{τ}(p), the one most similar to p may be offered by the procedure 200, according to the following equation:

c(p)=arg max_{q∈C}_{_{τ}}₍ₚ₎sim(p, q). (3)

In such a case, a cached item q may offer hits for those requests that fall inside a ball B_{τ}(q) of radius τ around q. In some cases, a cache maintenance policy may judiciously use such balls to operatively “cover” the space of such cached items.

At block 205, one or more cached object results may be returned. For example, one or more cached object results may be returned based at least in part on such a non-exact comparison at block 202. More specifically, cached object results associated with the closest matching ball identified at block 204 may be returned in cases where a cache hit has been determined at block 203. As discussed above with respect to blocks 140 and/or 144, identified cached object results may be returned to a user device 102 for presentation of one or more ads to an end user.

Additionally or alternatively, there may be a cache maintenance policy associated with operations 202, 204, 203 and 205 described above. In one example, operations 202, 204, 203 and 205 may be implemented as follows, for individual cached item p (i.e., both key(p) and val(p) are present in the cache, the keys of individual items served by p may be stored. For example, keys of individual items that operatively fall in the ball B=B_{τ}(p) may be stored in the cache. Individual balls may have a representative, rep(B), which may be initially p. Thus, the cache data organization may include a set of balls. In such a case, the key and value of a representative rep(B) and a set hst(B) of keys of past requests served by B may be operatively associated with individual balls B. A tightly clustered grouping of the items inside individual balls and a reduced overlapping between such balls may be performed to avoid redundancy. For example, such tight clustering and reduced overlap may be pursued by appropriately updating the representative in a ball according to a cache maintenance policy. Such a cache maintenance policy may operate as follows: on receiving a request p, a similarity of the request item with the representative of individual balls may be computed. In one example, the closest representative may be r=rep(B). Thus, if sim(r, p)<τ, then p may be fetched from the storage device to serve the request. In cases where sim(r, p)≧τ, then the request may be served based on items identified based at least in part on τ. In conjunction with operations 202, 204, 203 and 205 as described above, a cache maintenance policy, which may include one or more operations described below with respect to blocks 206-214, may be utilized to maintain the object cache prior to serving additional object requests.

Such a cache maintenance policy may include an eviction policy. Such an eviction policy can be realized in one of several ways. Two examples of such eviction policy are discussed below, including least recently used (LRU) and least frequently used (LFU). However, LRU and LFU are merely exemplary, and other eviction policies may be utilized with procedures 100, 200, and/or 300. A LRU policy may exploit the temporal locality in a request stream, e.g., recent requests may be likely to be re-requested in the near future. To implement this, LRU may associate, with individual items in the cache, a reference time that denotes a most recent moment when this item was used to serve a request. When needed, LRU may evict a cache item with the least reference time. On the other hand, a LFU policy may keep count of how many times individual cache items were hit in the past and may evict the least frequently used item when needed. The term “LFU” may include several variants of LFU. For example, it may happen in LFU that certain items occur in a burst to accumulate such high frequency counts that they may never get evicted from the cache. On such variant LFU includes a Window-LFU, which may deal with such “bursting” by counting the frequency of individual items within a recent finite length time-window.

In one example, such an eviction policy may include a LRU based policy as follows. Such an LRU based policy may, on receiving a request p, first determine if it is a hit or miss. If it is a hit, the reference time of c(p) may be updated. If it is a miss, item p may be brought to the cache, and a cached item with the oldest reference time may be evicted (as is consistent with LRU). Such a policy is referred to herein as similarity matching based LRU (referred to herein as SIM-LRU). A LFU based policy can also be formed in the same way to derive a similarity matching based LFU (referred to herein as SIM-LFU). Both SIM-LRU and/or SIM-LFU may include the following property: no two items in the cache may be within similarity r of each other. In this example, in other words, a cache may not contain any redundant items.

In one example, such a cache maintenance policy may potentially exploit the flexibilities offered by similarity caching. For example, it might be beneficial to bring a requested item into the cache even for a cache hit (under similarity). Additionally or alternatively, it might make sense to incrementally “re-organize” the object cache so that cached items are “well-separated” in the similarity space. Such operations may allow for a smaller cache size without a loss in effectiveness.

Such a cache maintenance policy may include one or more operations described below with respect to blocks 206-214. As will be discussed below, while SIM-LRU and SIM-LFU policies may operate so as to minimize redundant items in a cache, some redundancy may potentially creep in under these policies. For example, this can happen if the balls around individual cached item significantly overlap. Examples below may be described with respect to an LRU based policy as an example, however, the same and/or similar ideas may be applied to LFU based policies, and/or the like.

At block 206, a set of one or more keys may be tentatively updated with the query key. Such a set of one or more keys may include a representative cache key and past cache keys associated with the identified closest matching ball. For example, a query key p may be tentatively added to hst(B).

At block 208, a prospective key may be determined from the updated set of keys formed at block 206. For example, a prospective key may be determined based at least in part on a maximum sum of similarities between individual keys from the updated set of keys and cached object results operatively associated with the closest matching ball. In one example, to update the representative r of B, a total similarity score may be computed, for individual items in B. Such a computation can be performed incrementally to make its complexity linear in hst(B). For example, a prospective representative r′ may be found that has a maximum sum of similarity to individual items operatively within the ball, according to the following formula:

$${r}^{′} = arg {max}_{p ∈ hst ( B )} {\sum }_{q ∈ hst ( B )} sim ( p , q ) . \qquad ( 4 )$$

Such a maximum sum of similarities may be utilized so that a prospective representative r′ may “cover” the items operatively within its ball in an efficient manner. For example, such a maximum sum of similarities may be utilized so that a prospective representative r′ lies operatively close to the center of the ball.

At block 210, it may be determined if a similarity between a prospective key, identified at block 208, and those cached object results associated with the closest matching ball fall within a given tolerance. For example, a prospective representative r′ may be analyzed to see if it makes a better representative than the current representative r. In one example, for a prospective representative r′ to be selected to replace current representative r, an item r′.hst(B) may satisfy the following formula:

sim(r′, p)≧τ for each p.hst(B). (5)

This formulation may be utilized so that a prospective representative r′ may be found that may be used to serve those items operatively within the ball.

At block 212, in cases where the similarity between a prospective key and cached object results fall within a given tolerance, the representative cache key may be replaced with the prospective key. For example, the representative cache key may be replaced based at least in part on the determination of similarity made at block 210. In one example, the representative cache key may be replaced with the query key in cases where the query key has been selected as the prospective key at block 208. For example, for a prospective representative r′ that satisfies formula (4) one of following two scenarios can arise, a prospective representative r′ may also satisfy formula (5) or a prospective representative r′ may not also satisfy formula (5). In cases where a prospective representative r′ also satisfies formula (5), then rep(B)=r′ may be updated (so that a prospective representative r′ is selected to replace current representative r) and val(r′) may be fetched from the disk (this may cost an IO operation) to be included in the object cache.

At block 214, in cases where the similarity between a prospective key and cached object results fall outside a given tolerance, a new ball may be formed. For example a new ball operatively associated with the prospective key may be formed based at least in part on the determination of similarity made at block 210. In one example, a new ball operatively associated with the query key may be formed in cases where the query key has been selected as the prospective key at block 208. Additionally or alternatively, the prospective key identified at block 208 may be deleted from the updated set of keys in cases where a new ball is formed. For example, in cases where a prospective representative r′ does not also satisfy formula (5), then p may be deleted from hst(B), a new ball may be operatively formed around p, with p as its representative r; and ball B may be left unchanged. This may cost an IO operation. Such a cache maintenance policy including one or more operations described above with respect to blocks 206-214 may be referred to herein as a CLS-LRU policy.

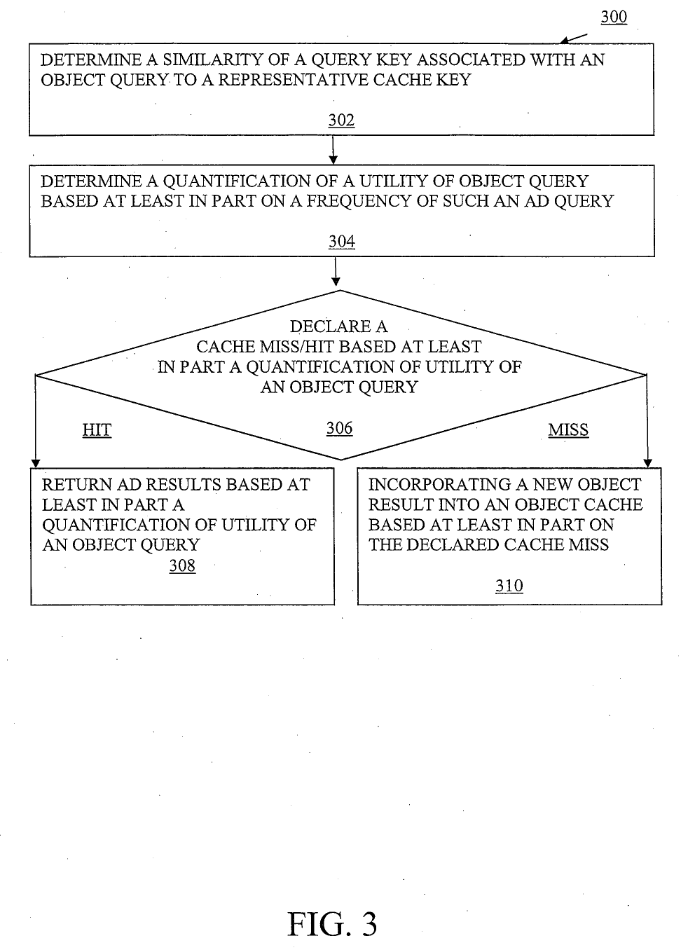

Referring to FIG. 3, a flow diagram illustrates a procedure 300 for operating an object cache in accordance with one or more exemplary embodiments. In operation, procedure 300 may be utilized to perform similarity caching in content-match systems, and/or the like. Procedure 300 may include a smooth objective that may dictate the efficiency-accuracy tradeoff during operation. As used herein the term “smooth objective” may refer to a smooth tradeoff between the IO cost and utility of offering an item similar (but not equal) to a requested item. As will be described below, procedure 300 may include a cache management policy that may operate in both LRU and LFU based cache management policies.

As discussed above with regard to block 202, a subsequent object query may be compared with one or more prior object queries. Under a threshold objective, discussed above with respect to FIG. 2, for a small ε>0, two cache hits with similarities τ and τ+ε may have the same utility, while under a smooth objective of procedure 300 two cache hits with similarities τ and τ+ε may not have the same utility. Hence, when a threshold-based cache management policy (such as SIM-LRU) is used, in cases where a request item p appears and has similarity τ to a cached item, such a policy may use this cached item to offer a hit. In doing so the policy may incur a utility loss of 1−util(τ). In cases where request item p appears too many times, such a loss can accumulate to become significant. On the other hand, an alternative operation might be to bring request item p in the cache (incurring an IO cost); in cases where it is believed that such an action might avoid a recurring utility loss. Such an operation to bring p in the cache may be worthwhile in cases where request item p is requested often enough. Accordingly, procedure 300 may operate as a next randomized cache maintenance policy (referred to herein as RND-LRU) that may operate so as to take such utility losses into account. Again, RND-LRU is described below in terms of LRU; however, such a cache maintenance policy may be adapted to apply to LFU, and/or the like, as well.

More specifically, at block 302 a similarity of a query key associated with an object query and a representative cache key associated with one or more cached object results in an object cache may be determined. Such similarity may be determined in a manner similar to that described above with respect to block 202 of FIG. 2.

At block 304, a quantification of a utility of an object query may be determined. For example, such a quantification of a utility of an object query may be determined based at least in part on a frequency of such an object query. In one example, such a quantification of utility may be defined by a utility function. Such a function util(•) may be utilized to control a tradeoff between a similarity of offered and requested items and input/output (IO) costs during cache maintenance. For instance, if util(s)=1 for s=1 and 0 otherwise, then such a formulation may be reduced to exact caching. In another example of such a utility function, which may be more relaxed than exact caching, util(s)=1 for s≧τ and 0 otherwise, where τ≦1 is a given threshold. A resulting objective may be referred to as a “threshold objective,” as is discussed above with respect to FIG. 2. Alternatively, such a utility function may, but does not have to be a threshold function. For example, such a utility function may be any monotone function. In such a case, such a utility function may be referred to herein as a “smooth objective”, as is discussed here with respect to FIG. 3.

At block 306, a cache miss or hit may be declared based at least in part such a quantification of utility of such an object query. At block 308, one or more cached object results may be returned. For example, one or more cached object results may be returned based at least in part on such a non-exact comparison identified at block 302 and/or based at least in part on a quantification of utility of an object query identified at block 304. As discussed above with respect to blocks 140 and/or 144, identified cached object results may be returned to a user device 102 for presentation of one or more ads to a user. Additionally or alternatively, there may be a cache maintenance policy associated with operations 302, 304 and 306 described above. At block 310, a new object result may be incorporated into such an object cache based at least in part on a declared cache miss. In one example, on receiving a request for item p, a RND-LRU policy may find a cached item q with a highest similarity to request for item p. Then with probability (1−util(sim(p, q))) the RND-LRU policy may declares a cache miss and reads item p from the storage device. With the remaining probability the RND-LRU policy may use cached item q to serve the request. Here α. [0, 1] may represent a smooth objective parameter that may control a utility vs. IO tradeoff. Observe that in cases where sim(p, q) is relatively low, then request for item p may be likely to be declared a cache miss (as desired). And if sim(p, q) is relatively high, then request for item p may be likely to be declared a hit. However, if request for item p occurs frequently enough, even in cases where sim(p, q) is relatively high, the RND-LRU policy may declare request for item p as a cache miss at some point and hence item p may be placed into the cache. Thus, the RND-LRU policy may trade off recurring utility losses verses IO costs based at least in part on monitoring frequencies of request for items p.

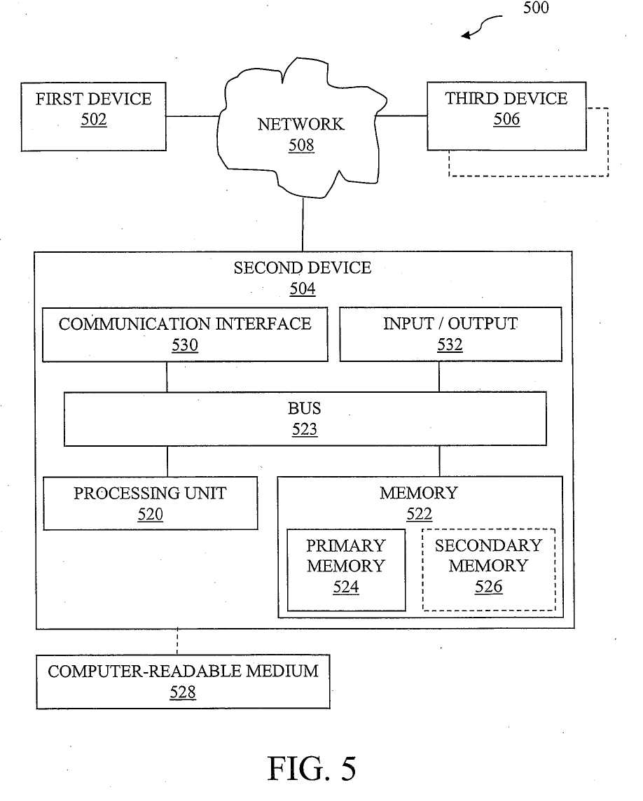

FIG. 5 is a block diagram illustrating an exemplary embodiment of a computing environment system 500 that may include one or more devices configurable to return cached object results using one or more exemplary techniques illustrated herein. For example, computing environment system 500 may be operatively enabled to perform all or a portion of process 100 of FIG. 1, process 200 of FIG. 2, and/or process 300 of FIG. 3.

Computing environment system 500 may include, for example, a first device 502, a second device 504 and a third device 506, which may be operatively coupled together through a network 508.

First device 502, second device 504 and third device 506, as shown in FIG. 5, are each representative of any device, appliance or machine that may be configurable to exchange data over network 508. By way of example, but not limitation, any of first device 502, second device 504, or third device 506 may include: one or more computing platforms or devices, such as, e.g., a desktop computer, a laptop computer, a workstation, a server device, storage units, or the like.

In the context of this particular patent application, the term “special purpose computing platform” means or refers to a general purpose computing platform once it is programmed to perform particular functions pursuant to instructions from program software. By way of example, but not limitation, any of first device 502, second device 504, or third device 506 may include: one or more special purpose computing platforms once programmed to perform particular functions pursuant to instructions from program software. Such program software does not refer to software that may be written to perform process 100 of FIG. 1, process 200 of FIG. 2, and/or process 300 of FIG. 3. Instead, such program software may refer to software that may be executing in addition to and/or in conjunction with all or a portion of process 100 of FIG. 1, process 200 of FIG. 2, and/or process 300 of FIG. 3.

Network 508, as shown in FIG. 5, is representative of one or more communication links, processes, and/or resources configurable to support the exchange of data between at least two of first device 502, second device 504 and third device 506. By way of example, but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 506, there may be additional like devices operatively coupled to network 508, for example.

It is recognized that all or part of the various devices and networks shown in system 500, and the processes and methods as further described herein, may be implemented using or otherwise include hardware, firmware, software, or any combination thereof.

Thus, by way of example, but not limitation, second device 504 may include at least one processing unit 520 that is operatively coupled to a memory 522 through a bus 523.

Processing unit 520 is representative of one or more circuits configurable to perform at least a portion of a data computing procedure or process. By way of example, but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 528. Computer-readable medium 528 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example, but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 532 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
with a computing platform:
determining a similarity of a query key associated with an object query to a representative cache key associated with one or more cached object results in an object cache, wherein said determination of similarity comprises a non-exact comparison; and
returning one or more of said cached object results based at least in part on said non-exact comparison.

2. The method of claim 1, wherein said computing platform comprises a special purpose computing platform.

3. The method of claim 1, wherein said returning said one or more of said cached object results comprises returning said one or more of said cached object results from said computing platform to a user device for presentation of one or more ads to a user.

4. The method of claim 1, wherein said non-exact comparison of said similarity is based at least in part on determining if said similarity of said query key falls within a given tolerance as compared to said representative cache key.

5. The method of claim 1, further comprising:
replacing said representative cache key with said query key based at least in part on determining that similarity between said query cache key and cached object results associated with said representative cache key fall within a given tolerance.

6. The method of claim 1, further comprising:
wherein said object cache comprises a ball-like organization comprising two or more balls, wherein individual balls of said object cache are associated with respective representative cache keys;
identifying a closest matching ball based at least in part on a comparison of said query key to said representative cache keys, wherein said non-exact comparison of said similarity is based at least in part on a comparison of said query key to said representative cache keys;
tentatively updating a set of one or more keys with said query key, wherein said set of keys comprises said representative cache key and past cache keys, wherein said set of keys is associated with said closest matching ball;
determine a prospective key from said updated set of keys based at least in part on a maximum sum of similarities between individual keys from said updated set of keys and cached object results associated with said closest matching ball; and
replacing said representative cache key with said prospective key based at least in part on determining that similarity between said prospective key and cached object results associated with said closest matching ball fall within a given tolerance.

7. The method of claim 1, further comprising:
wherein said object cache comprises a ball-like organization comprising two or more balls, wherein individual balls of said object cache are associated with respective representative cache keys; and
forming a new ball associated with said query key based at least in part on determining that similarity between said query key and cached object results associated with said representative cache key fall outside a given tolerance.

8. The method of claim 1, further comprising:
wherein said object cache comprises a ball-like organization comprising two or more balls, wherein individual balls of said object cache are associated with respective representative cache keys;
identifying a closest matching ball based at least in part on a comparison of said query key to said representative cache keys, wherein said non-exact comparison is based at least in part on a comparison of said query key to said representative cache keys;
tentatively updating a set of one or more keys with said query key, wherein said set of keys comprises said representative cache key and past cache keys, wherein said set of keys is associated with said closest matching ball;
determine a prospective key from said updated set of keys based at least in part on a maximum sum of similarities between individual keys from said updated set of keys and cached object results associated with said closest matching ball; and
deleting said prospective key from said updated set of keys and form a new ball associated with said prospective key based at least in part on determining that similarity between said prospective key and cached object results associated with said closest matching ball fall outside a given tolerance.

9. The method of claim 1,
determining a quantification of a utility of said object query based at least in part on a frequency of said object query; and
wherein said returning said one or more of said cached object results comprises returning said one or more of said cached object results based at least in part said quantification of utility of said object query.

10. The method of claim 1, further comprising:
determining a quantification of a utility of said object query based at least in part on a frequency of said object query; and
declaring a cache miss based at least in part said quantification of utility of said object query.

11. The method of claim 1, further comprising:
determining a quantification of a utility of said object query based at least in part on a frequency of said object query;
declaring a cache miss based at least in part said quantification of utility of said object query; and
incorporating a new object result into said object cache based at least in part on said declared cache miss.

12. The method of claim 1, wherein said non-exact comparison is based at least in part on locality sensitive hashing.

13. An article comprising:
a storage medium comprising machine-readable instructions stored thereon, which, if executed by one or more processing units, operatively enable a computing platform to:
determine a similarity of a query key associated with an object query to a representative cache key associated with one or more cached object results in an object cache, wherein said determination of similarity comprises a non-exact comparison; and
return one or more of said cached object results based at least in part on said non-exact comparison.

14. The article of claim 13, wherein said non-exact comparison is based at least in part on a determination if said similarity of said query key falls within a given tolerance as compared to said representative cache key.

15. The article of claim 13,
wherein said object cache comprises a ball-like organization comprising two or more balls, wherein individual balls of said object cache are associated with respective representative cache keys; and
wherein said machine-readable instructions, if executed by the one or more processing units, operatively enable the computing platform to: form a new ball associated with said query key based at least in part on determining that similarity between said query key and cached object results associated with said representative cache key fall outside a given tolerance.

16. The article of claim 13, wherein said machine-readable instructions, if executed by the one or more processing units, operatively enable the computing platform to:
determine a quantification of a utility of said object query based at least in part on a frequency of said object query;
declare a cache miss based at least in part said quantification of utility of said object query; and
incorporate a new object result into said object cache based at least in part on said declared cache miss.

17. An apparatus comprising:
a computing platform, said computing platform being operatively enabled to:
determine a similarity of a query key associated with an object query to a representative cache key associated with one or more cached object results in an object cache, wherein said determination of similarity comprises a non-exact comparison; and
return one or more of said cached object results based at least in part on a non-exact comparison.

18. The apparatus of claim 17, wherein said non-exact comparison is based at least in part on a determination if said similarity of said query key falls within a given tolerance as compared to said representative cache key.

19. The apparatus of claim 17,
wherein said object cache comprises a ball-like organization comprising two or more balls, wherein individual balls of said object cache are associated with respective representative cache keys; and
wherein said computing platform is further operatively enabled to: form a new ball associated with said query key based at least in part on determining that similarity between said query key and cached object results associated with said representative cache key fall outside a given tolerance.

20. The apparatus of claim 17, wherein said computing platform is further operatively enabled to:
determine a quantification of a utility of said object query based at least in part on a frequency of said object query;
declare a cache miss based at least in part said quantification of utility of said object query; and
incorporate a new object result into said object cache based at least in part on said declared cache miss.
